(19) United States
(12) Patent Application Publication
(10) Pub. No.: US 2009/0147295 A1
(43) Pub. Date: Jun. 11, 2009

(54) PAPER NAME DATABASE IN A PRINT SHOP MANAGEMENT SYSTEM

(75) Inventors: Rakesh Pandit, Irvine, CA (US); Geoff W. Harmon, Mission Viejo, CA (US)

Correspondence Address: YING CHEN;Chen Yoshimura LLP, 255 S. GRAND AVE., # 215, LOS ANGELES, CA, 90012, US

(73) Assignee: KONICA MINOLTA SYSTEMS LABORATORY, INC., Huntington Beach, CA (US)

(21) Appl. No.: 11/953,039

(22) Filed: Dec. 8, 2007

(51) Int. Cl. G06F 15/00

(52) U.S. Cl. 358/1.15

(57) ABSTRACT

A method for managing a print shop system having a plurality of printers connected to a management server is described. A paper name database is maintained on the server and each printer, and contains a plurality of paper name definitions each associating a paper name to a plurality of paper attributes such as paper size, weight, etc. The paper name databases are synchronized with each other. When creating a job ticket on the server, the operator specifies the paper name but does not need to specify the paper attributes. The server generates a job ticket containing the paper name and/or the paper attributes (retrieved from the paper name database using the paper name entered by the operator). When a printer receives a job ticket that contains a papa name, it retrieves the paper attributes associated with the paper name from the local paper name database and executes the job.

### BACKGROUND OF THE INVENTION

1. Field of the Invention

This invention relates to a print shop management system and method, and in particular, it relates to a method for uniformly specifying paper attributes by a print shop management system and printers managed by it.

2. Description of Related Art

In an environment that processes a large number of print jobs with multiple printers, there is a need to manage print jobs efficiently in an organized fashion. Examples of such an environment are professional print shops and print/copy departments at large organizations, where a variety of print requests, such as large-volume duplication and large document printing, needs to be processed and completed by utilizing multiple printers within a short turn-around time. These environments are collectively referred to as “print shops” in this application.

In a print shop environment, various kinds of papers are used. Each paper has a number of attributes associated with it, such as paper type (normal, coated, etc.), paper size, paper weight, paper color, punch property (whether the paper is pre-punched), etc. Conventionally, to specify a paper for use in a print job, the print shop operators have to specify all these attributes for the paper. Mis-specification can cause wastage. To more easily manage the papers used for copy production, many print shops maintain an internal catalog of paper used in the print shop. To differentiate between various papers, print shops often assign names to the different papers listed in the catalog. Generally, the paper name is an internal ID that is not meaningful outside the print shop. For instance, “Paper Name 1” may be used to indicate an 801b, 8½″×11″, green, Cascade-brand paper that also contains pre-punched holes. Currently, many printers allow the operator to define paper names at the device using an input panel of the device. Each printer can store and recognize a certain number of paper names.

### SUMMARY

While print shops currently use custom paper names as a useful shortcut, the paper names are not incorporated into the print shop management software and are not used in a uniform manner throughout the print shop to manage papers.

Accordingly, the present invention is directed to a method and apparatus useful in a print shop for managing paper names.

An object of the present invention is to allow the definitions of paper names to be consistent and uniform throughout the print shop.

Another object of the present invention is to enable an operator to create a job ticket by specifying a paper name without having to specify all paper attributes for the paper, and to enable the printers to correctly execute the job ticket using appropriate paper attributes.

Additional features and advantages of the invention will be set forth in the descriptions that follow and in part will be apparent from the description, or may be learned by practice of the invention. The objectives and other advantages of the invention will be realized and attained by the structure particularly pointed out in the written description and claims thereof as well as the appended drawings.

To achieve these and/or other objects, as embodied and broadly described, the present invention provides a method for managing a print shop, the print shop comprising a print shop management apparatus and a plurality of copy production devices connected thereto, the method including: generating a plurality of paper name definitions using the print shop management apparatus, each paper name definition including a paper name and a plurality of paper attributes associated with the paper name; storing the plurality of paper name definitions in a first paper name database on the print shop management apparatus; transferring the plurality of paper name definitions from the print shop management apparatus to each of the copy production devices; storing the paper name definitions in a second paper name database in each of the copy production devices; receiving a paper name for a job ticket at the print shop management apparatus; generating the job ticket by the print shop management apparatus, the job ticket including the paper name; transferring the job ticket from the print shop management apparatus to a copy production device; the copy production device retrieving from the second paper name databases a plurality of paper attributes associated with the paper name in the job ticket; and the copy production device executing the job ticket using the retrieved plurality of paper attributes.

In another aspect, the present invention provides a method for use in a print shop system comprising a print shop management apparatus and a plurality of copy production devices connected thereto, method being performed on the print shop management apparatus, including the following steps: (a) receiving a plurality of paper name definitions entered by an operator, each paper name definition including a paper name and a plurality of paper attributes associated with the paper name; (b) storing the plurality of paper name definitions in a paper name database; and (c) transferring the plurality of paper name definitions to each of the copy production devices.

The method may further includes (d) receiving a paper name for a job ticket; (e) generating the job ticket, wherein the job ticket includes either the paper name received from the operator, or a plurality of paper attributes associated with the paper name retrieved from the paper name database, or both; and (f) transferring the job ticket to one or more copy production devices.

In another aspect, the present invention provides a computer program product that causes a print shop management apparatus in a print shop to perform the above methods.

In another aspect, the present invention provides for use in a print shop system comprising a print shop management apparatus and a plurality of copy production devices connected thereto, the method being performed on a copy production device, including: (a) receiving a job ticket from the print shop management apparatus, the job ticket containing a paper name; (b) retrieving from a paper name database a plurality of paper attributes associated with the paper name contained in the job ticket, the paper name database storing a plurality of paper name definitions, each paper name definition including a paper name and a plurality of paper attributes associated with the paper name; and (c) executing the job ticket using the plurality of paper attributes retrieved in step (b).

The method may further include, prior to step (a): (d) receiving the plurality of paper name definitions from the print shop management apparatus; and (e) storing the plurality of paper name definitions in the paper name database.

In another aspect, the present invention provides a computer program product that causes a copy production device in a print shop to perform the above methods.

It is to be understood that both the foregoing general description and the following detailed description are exemplary and explanatory and are intended to provide further explanation of the invention as claimed.

### BRIEF DESCRIPTION OF THE DRAWINGS

FIG. 1 illustrates a print shop system implementing methods according to embodiments of the present invention.

FIG. 2 is a flow chart illustrating a method for creating and maintaining paper name databases in the print shop.

FIG. 3 shows an example of paper name definitions stored in a paper name database.

FIG. 4 is a flow chart illustrating a method for creating and executing a job ticked using the paper name database.

### DETAILED DESCRIPTION OF PREFERRED EMBODIMENTS

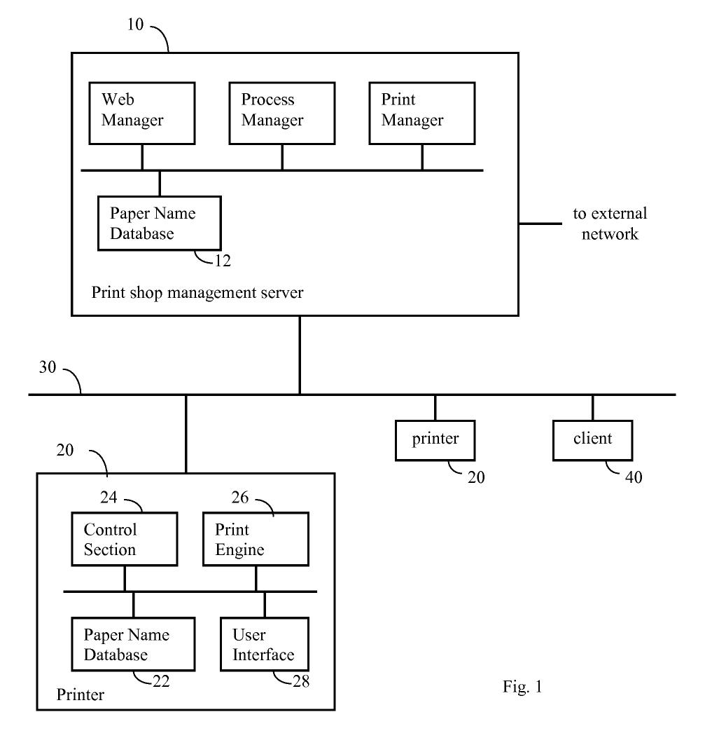

Embodiments of the present invention provide a method and apparatus useful in a print shop for managing the various types of papers used by the printer and copier devices within the print shop. As schematically illustrated in FIG. 1, a print shop system includes a print shop management server 10 and a plurality of copy production devices 20 such as printers, copiers, scanners, finishing machines or the like, connected to a server 10 via a network 30. The server 10 executes print shop management software to manage print jobs and the various devices in the print shop. The server 10 may be any type of data processing apparatus, such as a personal computer, a workstation, etc. The print shop management software is preferably stored in a storage medium, such as an HD (Hard Disk) and a CPU (Central Processing Unit) of the server 10 reads out the software to a RAM (Random Access Memory) of the server to execute the same. The server 10 is preferably also connected to an external network such as the Internet for receiving print jobs (i.e. print requests from customers and documents to be printed). One or more client computers 40 may also be connected to the server 10 by the network 30 to enable print shop operators to interact with the server and the rest of the system. As described below, the print shop management server 10 and each of the copy production devices 20 maintains a paper name database 12, 22 for storing paper name definitions. The server 12 executing the print shop management software is referred to as the print shop management apparatus in this disclosure.

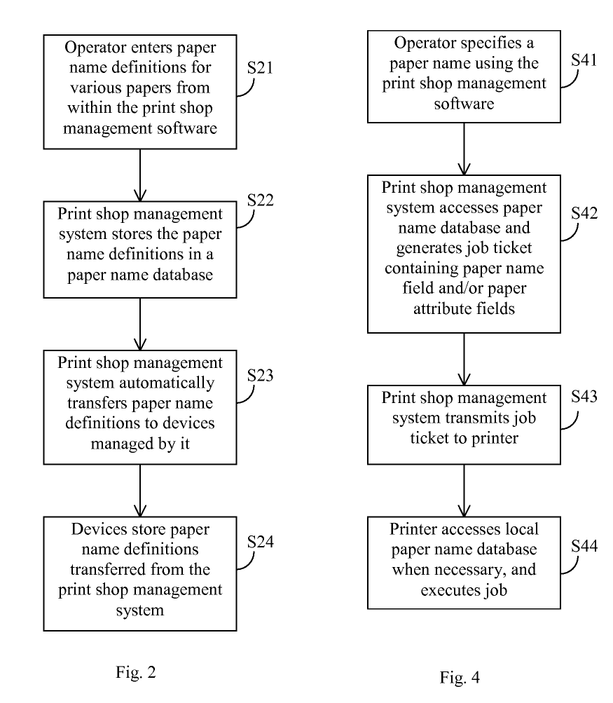

In addition to its other functions, the server 10 executing the print shop management software manages the definition of paper names for all devices connected to the server. Prior to this invention, while paper names can be defined for a printer or copier device using the device's input panel, there was no system that guarantees that a particular paper name defined in one device and the same paper name defined in another device actually refer to the same paper. Embodiments of the present invention provide a way to ensure uniformity of the paper names defined on the server and within each device of the print shop. In one embodiment of the present invention, as shown in FIG. 2, an operator enters definitions of paper names for various papers using the print shop management software (step S21). For each paper, the operator specifies a paper name and the values of the various attributes of the paper such as paper manufacturer, paper color, paper weight, paper size, etc. An appropriate graphic user interface such as a dialog box may be used for this purpose. These paper name definitions (each definition including the paper name and the values of the various attributes associated with the paper name) are stored in a paper name database 12 on the server (step S22). In addition to inputting the paper name definitions by an operator, some paper manufacturers provide electronic paper catalogs that can be imported into the print shop management system and stored as a part of the paper name database 12.

After the paper names are defined, the print shop management system automatically transfers the paper name definitions to the devices 20 managed by it (step S23), where they are stored in a local paper name database 22 (step S24). The data may be transferred between the server 10 and the device 20 through an http interface or other suitable channels. Thereafter, when paper name definitions are added or changed by the operator using the print management software, the new paper name definitions are transferred to the devices and stored there. When new devices are added to the print shop system, the paper name definition is transferred to the new devices and stored there. As a result, the paper name definitions are uniform across the server and the devices managed by the print shop management system. According to the present embodiment it is no longer necessary to define paper names at each individual device.

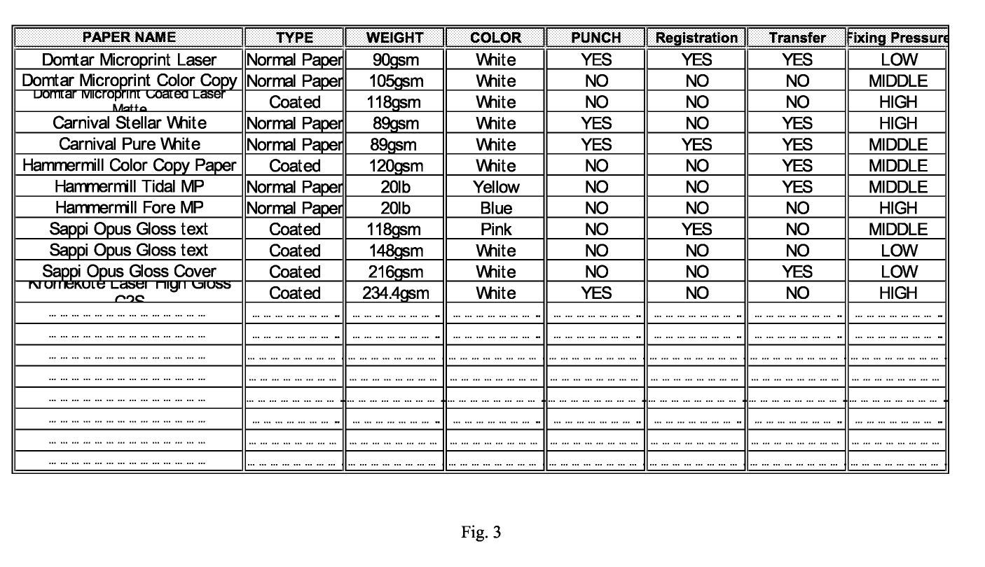

The paper name definitions stored in the database 12 can be conveniently displayed to the operator for easy reference, for example, in a spreadsheet format. FIG. 3 shows an example of a displayed list of paper name definitions. In this example, “Registration” refers to whether the main face of the paper is the back or the front, whether registration should be adjusted, whether magnification adjustment is necessary, etc. “Transfer” refers to whether the electric current of image transfer should be adjusted. “Fixing Pressure” refers to the strength of fixing pressure. Of course, these specific attributes are only examples; other appropriate attributes may be used as determined by the print shop.

As shown in FIG. 1, each printer, copier, etc. device 20 (a printer is show with more detail as an example) has a control section 24 which controls the various functions of the device. The control section 24 of the printer 20 additionally performs the function of communicating with the server 10 to receive the paper name definitions from the server and store it in the paper name database 22 of the printer 20. In addition, the control section 24 may allow an operator to enter paper name definitions using the user interface 28 (e.g. a user input panel) on the printer 20. When paper name definitions are added or changed by the operator from the printer 20, they are stored in the paper name database 22 and transferred to the server 10. The server 10 stores the paper name definitions received from the printer 20 in the paper name database 12 on the server, and further transfers these paper name definitions to other devices 20 managed by the server.

After the paper names are stored in the paper name database 12 on the server 10 and the paper name databases 22 on each device 20, they may be used throughout the print shop system in managing and executing print jobs. In a typical process, an operator creates a job ticket for a print job using the print shop management software. A job ticket is a collection of parameters that describe a customer's print job. The parameters may include the number of copies, orientation, the paper to be used, input tray, output tray, finishing instructions, etc. When creating a job ticket, by using the paper name database 12, the operator can easily specify the paper to be used by specifying the paper name without having to manually enter all of the paper attributes for that paper. To specify the paper name, the operator may type in the paper name; alternatively, the print shop management software may display a list (i.e. a drop-down menu) of paper names with the associated paper attributes for the operator to choose from. Based on the paper name specify by the operator, the print shop management software fill in or modify the fields in the job ticket regarding the paper to be used. In one embodiment, the job ticket contains both a paper name field and a number of paper attribute fields, such as paper type, paper size, paper weight, paper color, etc. The print shop management software fills out the paper attribute fields based on the paper name using the information stored in the paper name database 12. Such a job ticket can be used by all printers (both those that have a local paper name database 22, and those that do not have a local paper name database). In an alternative embodiment, the job ticket contains the paper attribute fields but no paper name fields. Such job tickets can also be used by all printers. In this embodiment, although the job tickets are the same as conventional job tickets, the operator no longer needs to manually specify all the paper attributes. In another alternative embodiment, the job ticket contains only a paper name field, and no fields for the actual paper attributes. Such a job ticket can be sent to and correctly executed by a printer 20 that has a paper name database 22 that contains identical paper name definitions as the paper name database 12 on the server (i.e. the two paper name databases have been synchronized). In such a case, the printer 20 receives the job ticket, accesses the local paper name database 22 to retrieve the paper attributes corresponding to the paper name, and execute the print job using these paper attributes.

FIG. 4 summarizes the process described above. First, when creating a job ticket, the operator specifies a paper name for the job (step S41). The print shop management system accesses the paper name database 12 to retrieve paper attributes associated with the paper name, and creates the job ticket that contains either a paper name field or paper attribute fields or both (step S42). The job ticket is transmitted to a printer for execution (step S43). If the job ticket does not contain the paper attribute fields and only contains a paper name field, the printer accesses its local paper name database 22 to retrieve the paper attributes associated with the paper name, and executes the job ticket (i.e. performing the print job defined by the job ticket) (step S44).

In addition to creating job tickets at the server, the paper name databases can also be used by an operator to enter jobs directly at printer or copier devices. Because the paper name definitions are synchronized on all devices and the server in the print shop, the operator can specify a paper name for the paper to be used for the job at any device without being concerned about inconsistent paper name definitions at different devices.

If the print shop management software has multiple components (software modules or applications), the paper name database on the server may be shared by the multiple components so that the paper name definitions can be used by all such components. In the examples schematically shown in FIG. 1, the print shop management software includes a web submission component that allows users to create jobs and submit them directly to the print shop, a process manager, a central hub through which jobs are tracked through the entire process from inception to print to billing, and a print manager for modifying and processing jobs through the attached printers. All of these components can share the same paper name database 12. Between the applications, paper name data can be exchanged between through http APIs.

By standardizing the paper name database, the print shop is able to reduce time filling out job tickets, and save time by not having to identify paper names on a device-by-device basis. Additionally, wasted resources (physical and man hours) are also reduced since a paper name is universally understood by all components of the print shop management and all supported printer and copier devices.

In the above-described embodiments, the paper name database are maintained at the server 10 and each printer separately. In an alternative embodiment, a single paper name database may be stored on a storage device connected to the network 30, and is accessible by both the server 10 and the printers 20.

In the above descriptions, print jobs are used as examples of copy production jobs. Copy production jobs may also be copy jobs. The method describe above applies to both print and copy jobs. Also, the term “print shop” should be understood to broadly include any establishment that handles production requests, such as commercial print shops, copy production centers within organizations, etc.

It will be apparent to those skilled in the art that various modification and variations can be made in the overage management method and apparatus of the present invention without departing from the spirit or scope of the invention. Thus, it is intended that the present invention cover modifications and variations that come within the scope of the appended claims and their equivalents.

What is claimed is:

1. In a print shop system comprising a print shop management apparatus and a plurality of copy production devices connected thereto, a print shop management method performed on the print shop management apparatus, comprising:
(a) receiving a plurality of paper name definitions, each paper name definition including a paper name and a plurality of paper attributes associated with the paper name;
(b) storing the plurality of paper name definitions in a paper name database; and
(c) transferring the plurality of paper name definitions to each of the copy production devices.

2. The method of claim 1, wherein the paper attributes include one or more of paper type, paper size, paper weight, paper color, punch property, registration, transfer, and fixing pressure.

3. The method of claim 1, further comprising:
(d) receiving a paper name for a job ticket;
(e) generating the job ticket, wherein the job ticket includes either the paper name received from the operator, or a plurality of paper attributes associated with the paper name retrieved from the paper name database, or both; and
(f) transferring the job ticket to one or more copy production devices.

4. In a print shop system comprising a print shop management apparatus and a plurality of copy production devices connected thereto, a method performed on a copy production device, comprising:
(a) receiving a job ticket from the print shop management apparatus, the job ticket containing a paper name;
(b) retrieving from a paper name database a plurality of paper attributes associated with the paper name contained in the job ticket, the paper name database storing a plurality of paper name definitions, each paper name definition including a paper name and a plurality of paper attributes associated with the paper name; and
(c) executing the job ticket using the plurality of paper attributes retrieved in step (b).

5. The method of claim 4, further comprising, prior to step (a):
(d) receiving the plurality of paper name definitions from the print shop management apparatus; and
(e) storing the plurality of paper name definitions in the paper name database.

6. The method of claim 4, further comprising:
(f) receiving a paper name definition from an operator; and
(g) storing the paper name definition received in step (f) in the paper name database.

7. The method of claim 6, further comprising:
(h) transferring the paper name definition received in step (f) to the print shop management apparatus.

8. A computer program product comprising a computer usable medium having a computer readable code embodied therein for controlling a print shop management apparatus, the computer readable program code configured to cause the print shop management apparatus to execute a process for managing a print shop system, the print shop system including the print shop management apparatus and a plurality of copy production devices connected thereto, the process comprising the steps of:
(a) receiving a plurality of paper name definitions, each paper name definition including a paper name and a plurality of paper attributes associated with the paper name;
(b) storing the plurality of paper name definitions in a paper name database; and
(c) transferring the plurality of paper name definitions to each of the copy production devices.

9. The computer program product of claim 8, wherein the paper attributes include one or more of paper type, paper size, paper weight, paper color, punch property, registration, transfer, and fixing pressure.

10. The computer program product of claim 8, the process further comprising the steps of:
(d) receiving a paper name for a job ticket;
(e) generating the job ticket, wherein the job ticket includes either the paper name received from the operator, or a plurality of paper attributes associated with the paper name retrieved from the paper name database, or both; and
(f) transferring the job ticket to one or more copy production devices.

11. A computer program product comprising a computer usable medium having a computer readable code embodied therein for controlling a copy production device in a print shop, the copy production device being connected to a print shop management apparatus, the computer readable program code configured to cause the copy production device to execute a process comprising the steps of:
(a) receiving a job ticket from the print shop management apparatus, the job ticket containing a paper name;
(b) retrieving from a paper name database a plurality of paper attributes associated with the paper name contained in the job ticket, the paper name database storing a plurality of paper name definitions, each paper name definition including a paper name and a plurality of paper attributes associated with the paper name; and
(c) executing the job ticket using the plurality of paper attributes retrieved in step (b).

12. The computer program product of claim 11, the process further comprising, prior to step (a):
(d) receiving the plurality of paper name definitions from the print shop management apparatus; and
(e) storing the plurality of paper name definitions in the paper name database.

13. The computer program product of claim 11, the process further comprising:
(f) receiving a paper name definition from an operator; and
(g) storing the paper name definition received in step (f) in the paper name database.

14. The computer program product of claim 13, the process further comprising:
(h) transferring the paper name definition received in step (f) to the print shop management apparatus.

15. A method for managing a print shop, the print shop comprising a print shop management apparatus and a plurality of copy production devices connected thereto, the method comprising:
generating a plurality of paper name definitions using the print shop management apparatus, each paper name definition including a paper name and a plurality of paper attributes associated with the paper name;
storing the plurality of paper name definitions in a first paper name database on the print shop management apparatus;
transferring the plurality of paper name definitions from the print shop management apparatus to each of the copy production devices;
storing the paper name definitions in a second paper name database in each of the copy production devices;
receiving a paper name for a job ticket at the print shop management apparatus;
generating the job ticket by the print shop management apparatus, the job ticket including the paper name;
transferring the job ticket from the print shop management apparatus to a copy production device;
the copy production device retrieving from the second paper name databases a plurality of paper attributes associated with the paper name in the job ticket; and
the copy production device executing the job ticket using the retrieved plurality of paper attributes.
